(19) United States
(12) Patent Application Publication
(10) Pub. No.: US 2009/0055398 A1
(43) Pub. Date: Feb. 26, 2009

(54) RETRIEVING MOBILE USER CONTEXT INFORMATION USING TOKENIZED VIRTUAL DICTIONARIES

(75) Inventors: Tong Zhu, Fremont, CA (US); Venkata Narasimha Rao Yerubandi, Sunnyvale, CA (US); Kenneth Tsz Ho, Belmont, CA (US); Jiuhe Gan, Cupertino, CA (US)

Correspondence Address: Yahoo! Inc.;c/o DARBY & DARBY P.C., P.O. BOX 770, Church Street Station, NEW YORK, NY, 10008-0770, US

(73) Assignee: Yahoo! Inc., Sunnyvale, CA (US)

(21) Appl. No.: 11/843,167

(22) Filed: Aug. 22, 2007

(51) Int. Cl. G06F 17/30

(52) U.S. Cl. 707/10; 707/E17.009

(57) ABSTRACT

A network device, system, and method are directed towards providing user context information to improve relevancy of a search result, or other content, provided to a user. A context service may provide a common retrieval interface (CRI) that reflects the capabilities available to a content service application (CSA). The CSA may provide limited information about the user to the context service and may specify user context information being sought. The context service provides at least some of the known user information to various context analysis services to request the user context information, and receives back user context information along with a confidence level indicating a percentage of confidence the context analysis service may have for the results. The context service then selects user context information based on weighted confidence levels, and provides the results to the CSA, to improve the relevancy of information provided to the user.

### TECHNICAL FIELD

The present invention relates generally to query retrievals and, more particularly, but not exclusively to determining user contextual information for use in an application to improve a relevance of information sent to a mobile device user.

### BACKGROUND

The growth of the Internet has brought a corresponding increase in the number and variety of computing devices being employed to communicate over the Internet. Today's computing devices vary from desktop computers with a large variety of features and capabilities, to mobile devices such as pagers, cellular phones, personal digital assistants (PDAs), and the like, with lesser features and/or capabilities. For example, many of these computing devices include some form of Internet browsing and/or search capability. However, the results of such browsing and/or searches may not always be what the user may have been looking for. In some instances, the results may even be irrelevant to the user. Such results may be frustrating to the user and may even result in decreased marketing and/or sales opportunities by on-line businesses. Therefore, it is with respect to these considerations and others that the present invention has been made.

### BRIEF DESCRIPTION OF THE DRAWINGS

Non-limiting and non-exhaustive embodiments of the present invention are described with reference to the following drawings. In the drawings, like reference numerals refer to like parts throughout the various figures unless otherwise specified.

For a better understanding of the present invention, reference will be made to the following Detailed Description, which is to be read in association with the accompanying drawings, wherein:

FIG. 1 is a system diagram of one embodiment of an environment in which the invention may be practiced;

FIG. 2 shows one embodiment of a mobile device that may be included in a system implementing the invention;

FIG. 3 shows one embodiment of a network device that may be included in a system implementing the invention; and

FIG. 4 illustrates a logical flow diagram generally showing one embodiment of an overview of a process for performing a search for user context information using virtual dictionaries, in accordance with the present invention.

### DETAILED DESCRIPTION

The present invention now will be described more fully hereinafter with reference to the accompanying drawings, which form a part hereof, and which show, by way of illustration, specific embodiments by which the invention may be practiced. This invention may, however, be embodied in many different forms and should not be construed as limited to the embodiments set forth herein; rather, these embodiments are provided so that this disclosure will be thorough and complete, and will fully convey the scope of the invention to those skilled in the art. Among other things, the present invention may be embodied as methods or devices. Accordingly, the present invention may take the form of an entirely hardware embodiment, an entirely software embodiment or an embodiment combining software and hardware aspects. The following detailed description is, therefore, not to be taken in a limiting sense.

Throughout the specification and claims, the following terms take the meanings explicitly associated herein, unless the context clearly dictates otherwise. The phrase “in one embodiment” as used herein does not necessarily refer to the same embodiment, though it may. Furthermore, the phrase “in another embodiment” as used herein does not necessarily refer to a different embodiment, although it may. Thus, as described below, various embodiments of the invention may be readily combined, without departing from the scope or spirit of the invention.

In addition, as used herein, the term “or” is an inclusive “or” operator, and is equivalent to the term “and/or,” unless the context clearly dictates otherwise. The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

Briefly stated the present invention is directed towards providing user context information useable to improve the relevancy of a search result, or other content that may be provided to a user, such as through a content service application (CSA), or the like. In one embodiment, the content is provided in response to a request from the user. In another embodiment, the content may be provided based on an event, alert, or the like.

During initialization of a context service, the context service may query a variety of analysis services to obtain a list of capabilities, and keyword dictionary interfaces. The analysis services are configured to provide user context information, such as location information, message history information, user account information, or the like. The context service may generate a global virtual dictionary and common retrieval interface (CRI) that reflects the capabilities of the various context analysis services available for use by various CSAs.

A content service application (CSA), such as search query application, advertisement application, or the like, may employ the CRI to request user context information to improve the relevancy of information to be provided to a user. In one embodiment, the CSA may provide information about the user to the context service, including for example, a user's phone number, contents of a message sent by the user, a user's message carrier's identifier, an address of where the message is being sent to by the user, including perhaps a short code, long code, or the like. In addition, in one embodiment, the CSA may specify a type of user context information being sought, such as user location information, user account information, user preferences, behavior information, or the like, using the CRI. The context service may, in one embodiment, examine the message body, or other provided user information to extract any relevant information associated with the user context information being sought. The context service may then provide at least some of the user information to a subset of the various context analysis services to request the user context information being sought. The subset context analysis services may return user context information along with a confidence level indicating a percentage of confidence the context analysis service may have for the results.

The context service may, based on feedback history of prior results for a given context analysis service, weight the received confidence level from that context analysis service. The context service may then select user context information based on the weighted confidence levels. The selected user context information may then be provided to the CSA, where the CSA may then employ the user context information to improve the relevancy of content provided to the user.

In one embodiment, the communication between the CSA and the user employs Short Message Service (SMS). However, the invention is not so limited, and other messaging protocols may also be used, including, but not limited to Multimedia Message Service (MMS), instant messaging (IM), web browsing using such as HyperText Transfer Protocol (HTTP), email, or the like. Moreover, in one embodiment, the user receiving the information from the CSA may employ a mobile device. However, the invention is not constrained to mobile devices, and virtually any client computing device may be used by the user.

### Illustrative Operating Environment

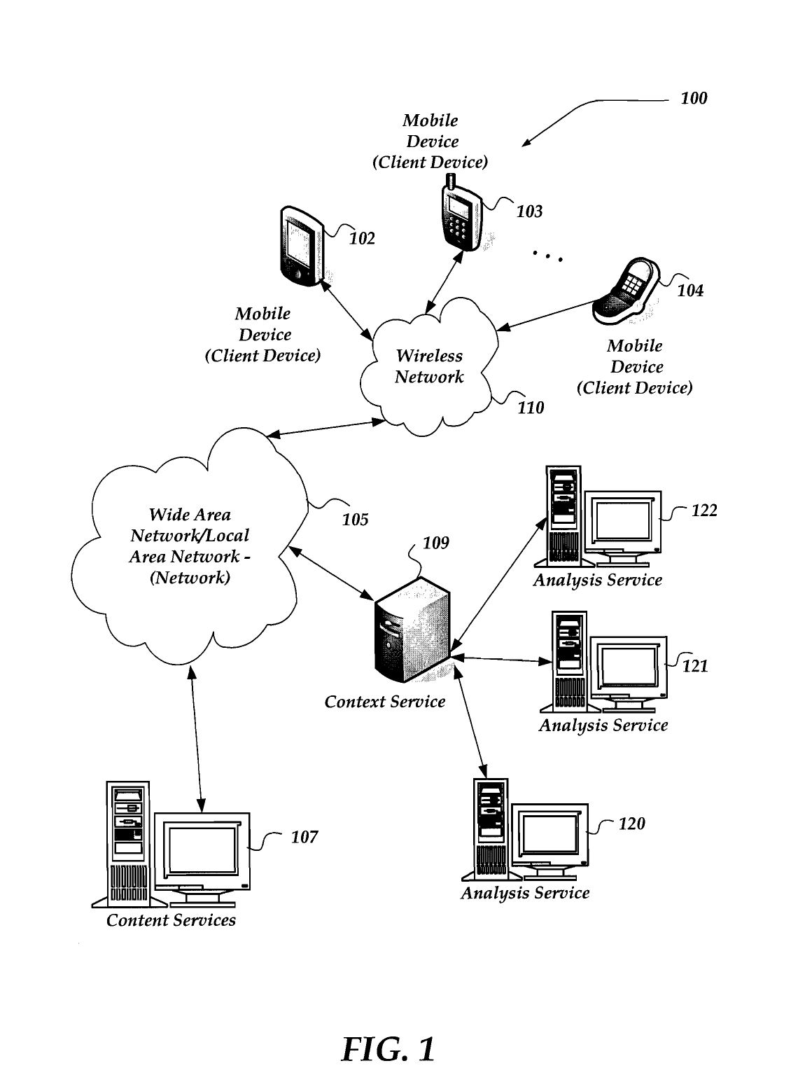

FIG. 1 shows components of one embodiment of an environment in which the invention may be practiced. Not all the components may be required to practice the invention, and variations in the arrangement and type of the components may be made without departing from the spirit or scope of the invention. As shown, system 100 of FIG. 1 includes local area networks (“LANs”)/wide area networks (“WANs”)—(network) 105, wireless network 110, mobile devices (client devices) 102-104, content services 107, context service 109, and analysis services 120-122.

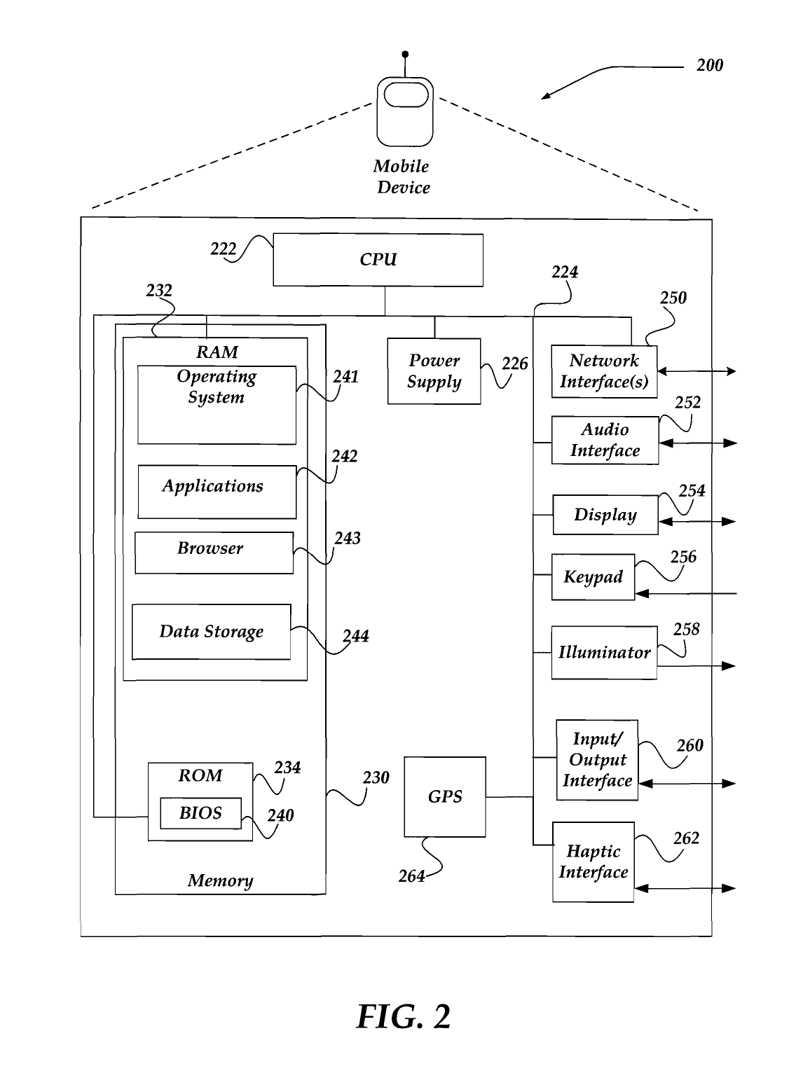

One embodiment of mobile devices 102-104 is described in more detail below in conjunction with FIG. 2. Generally, however, mobile devices 102-104 may include virtually any portable computing device capable of receiving and sending information over a network, such as network 105, wireless network 110, or the like. Mobile devices 102-104 may also be described generally as client devices that are configured to be portable. Such portable devices include computing devices such as, cellular telephones, smart phones, display pagers, radio frequency (RF) devices, infrared (IR) devices, Personal Digital Assistants (PDAs), handheld computers, laptop computers, wearable computers, tablet computers, integrated devices combining one or more of the preceding devices, and the like. As such, mobile devices 102-104 typically range widely in terms of capabilities and features. For example, a cell phone may have a numeric keypad and a few lines of monochrome LCD display on which only text may be displayed. In another example, a web-enabled mobile device may have a touch sensitive screen, a stylus, and several lines of color LCD display in which both text and graphics may be displayed. Moreover, mobile devices 102-104 may have limited memory page footprints. For example, one mobile device may be physically limited to 10 Kbytes of a memory page footprint (size constraint), while another mobile device may be physically limited to some other size of memory page footprint.

A web-enabled mobile device may include a browser application that is configured to receive and to send web pages, web-based messages, and the like. The browser application may be configured to receive and display graphics, text, multimedia, and the like, employing virtually any web based language, including a wireless application protocol messages (WAP), and the like. In one embodiment, the browser application is enabled to employ Handheld Device Markup Language (HDML), Wireless Markup Language (WML), WMLScript, JavaScript, Standard Generalized Markup Language (SMGL), HyperText Markup Language (HTML), eXtensible Markup Language (XML), Compact HTML (cHTML), EXtensible HTML (xHTML), or the like, to display and send a message.

Mobile devices 102-104 also may include at least one other client application that is configured to receive content from another computing device. The client application may include a capability to provide and receive textual content, graphical content, audio content, and the like. The client application operates as user-agent to further provide information that identifies the mobile device, including a type, capability, name, or the like. In one embodiment, mobile devices 102-104 may uniquely identify themselves through any of a variety of mechanisms, including a phone number, Mobile Identification Number (MIN), an electronic serial number (ESN), a network address, or other device identifier. The information may also indicate a content format, and/or a capability of the mobile device. For example, in one embodiment, the client application (or user-agent) may be configured to provide information about a type of mobile device, an application available on the mobile device, a memory page footprint (or memory page size constraint) for the mobile device, or the like. In one embodiment, the client application may be implemented as an application, a script, applet, or the like.

Mobile devices 102-104 may also be configured to communicate a message, such as through Short Message Service (SMS), Multimedia Message Service (MMS), instant messaging (IM), internet relay chat (IRC), Jabber, and the like, between itself and another computing device. However, the present invention is not limited to these messaging protocols, and virtually any other messaging protocol may be employed.

Moreover, although FIG. 1 illustrates client devices as mobile devices, the invention is not so limited, and virtually any client computing device may be employed with system 100, without departing from the scope of the invention. Thus, for example, a user may also employ computing devices that typically connect using a wired communications medium such as personal computers, multiprocessor systems, microprocessor-based or programmable consumer electronics, network PCs, or the like, or even computing devices that may be configured to employ wired and/or wireless communications mediums, such as laptops, or the like.

Wireless network 110 is configured to couple mobile devices 102-104 with network 105. Wireless network 110 may include any of a variety of wireless sub-networks that may further overlay stand-alone ad-hoc networks, and the like, to provide an infrastructure-oriented connection for mobile devices 102-104. Such sub-networks may include mesh networks, Wireless LAN (WLAN) networks, cellular networks, and the like.

Wireless network 110 may further include an autonomous system of terminals, gateways, routers, and the like connected by wireless radio links, and the like. These connectors may be configured to move freely and randomly and organize themselves arbitrarily, such that the topology of wireless network 110 may change rapidly.

Wireless network 110 may further employ a plurality of access technologies including 2nd (2G), 3rd (3G) generation radio access for cellular systems, WLAN, Wireless Router (WR) mesh, and the like. Access technologies such as 2G, 3G, and future access networks may enable wide area coverage for mobile devices, such as mobile devices 102-104 with various degrees of mobility. For example, wireless network 110 may enable a radio connection through a radio network access such as Global System for Mobil communication (GSM), General Packet Radio Services (GPRS), Enhanced Data GSM Environment (EDGE), Wideband Code Division Multiple Access (WCDMA), and the like. In essence, wireless network 110 may include virtually any wireless communication mechanism by which information may travel between mobile devices 102-104 and another computing device, network, and the like.

Network 105 is configured to enable customizer services 109, and/or content services 107 to communicate with other computing devices, including, through wireless network 110 with mobile devices 102-104. Network 105 is enabled to employ any form of computer readable media for communicating information from one electronic device to another. Also, network 105 can include the Internet in addition to local area networks (LANs), wide area networks (WANs), direct connections, such as through a universal serial bus (USB) port, other forms of computer-readable media, or any combination thereof. On an interconnected set of LANs, including those based on differing architectures and protocols, a router acts as a link between LANs, enabling messages to be sent from one to another. Also, communication links within LANs typically include twisted wire pair or coaxial cable, while communication links between networks may utilize analog telephone lines, full or fractional dedicated digital lines including T1, T2, T3, and T4, Integrated Services Digital Networks (ISDNs), Digital Subscriber Lines (DSLs), wireless links including satellite links, or other communications links known to those skilled in the art. Furthermore, remote computers and other related electronic devices could be remotely connected to either LANs or WANs via a modem and temporary telephone link. In essence, network 105 includes any communication method by which information may travel between one computing device and other computing devices.

Additionally, communication media typically embodies computer-readable instructions, data structures, program modules, or other data in a modulated data signal such as a carrier wave, data signal, or other transport mechanism and includes any information delivery media. The terms “modulated data signal,” and “carrier-wave signal” includes a signal that has one or more of its characteristics set or changed in such a manner as to encode information, instructions, data, and the like, in the signal. By way of example, communication media includes wired media such as twisted pair, coaxial cable, fiber optics, wave guides, and other wired media and wireless media such as acoustic, RF, infrared, and other wireless media.

Content services 107 may be configured to operate as a website server to provide content to client devices 102-104. Such content may include, but is not limited to webpage content, advertisements, search results, or the like. However, content services 107 is not limited to web servers, and may also operate as a messaging server such as an SMS message service, IM message service, email message service, alert server, or the like. Moreover, content services 107 may also operate as a File Transfer Protocol (FTP) server, a database server, music and/or video download server, or the like. Additionally, content services 107 may be configured to perform multiple functions. Thus, for example, content services 107 may be configured as a messaging server, and as a database server. Moreover, while content services 107 may operate as other than a website, content services 107 may still be enabled to receive a request for web content, documents, or the like.

In one embodiment, content services 107 may receive a request for information from a client device, such as client devices 102-104. Content services 107 may also receive user information, such as a phone number, MIN, ESN, a network address, or other device identifier, along with a network carrier's identifier, or the like. Content services 107 may then employ the provided user information to obtain user context information, such as user location information, user account information, user preferences, user query history, or the like. In one embodiment, content services 107 may also employ information within the request from the client device to obtain user context information. Content services 107 may request the user context information from context server 109 using a standardized common retrieval interface (CRI) format. However, the content services 107 are not constrained to employing the CRI, and other mechanisms may be used to request the user context information.

Content services 107 may receive the user context information from context service 109 and employ it to improve a relevancy of a response to the request for information. For example, consider where the user requests a search to be performed. Content services 107 may employ the user context information to modify a search query to improve the relevancy of the search results. For example, the user context information might include a location of the user. The search query may then be modified to include the user's location context information. The invention is not limited to this example, however, and other applications may also be employed. As another example, content services 107 may select to include an advertisement in an alert, email, or other message being sent to the user. Content services 107 may then employ user context information to select an advertisement that is directed towards being relevant to the user. In yet another example, content services 107 may receive a message or alert from another application, user, or the like, and attempt to determine how the message is to be sent to the a destination user. In this example, the destination user might have specified that if the message is of one type, send it as an alert to the destination user's mobile device using a particular user account. If the message is of another type, send the alert to the user's mobile device using a different user account. Thus, content services 107 may seek to determine the user context information pertaining to which user account to send the message.

It should be noted that while a single network device is illustrated for content services 107, the invention is not so limited. Rather, content services 107 merely represent one of a plurality of possible content services that may be available for use within system 100. Thus, in one embodiment, content services may be distributed across a plurality of different network devices, without departing from the scope of the invention.

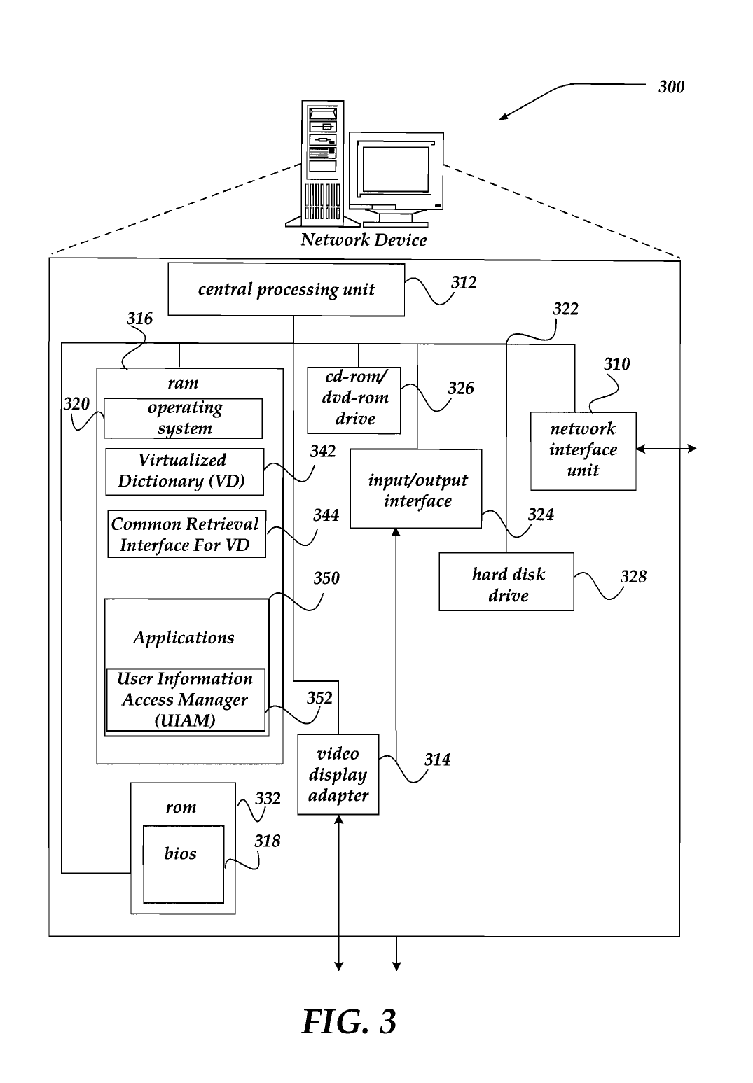

One embodiment of context service 109 is described in more detail below in conjunction with FIG. 3. Briefly, however, context service 109 is configured to receive a request for user context information, request the user context information from a variety of analysis services 120-122. The analysis services 120-122 may return a guess of what the requested user context information may be, along with a confidence level value indicating a percent likelihood that the guess is correct. Context service 109 may then select from the returned guesses of user context information and provide the selected user context information to the requester. In one embodiment, the request is from content services 107.

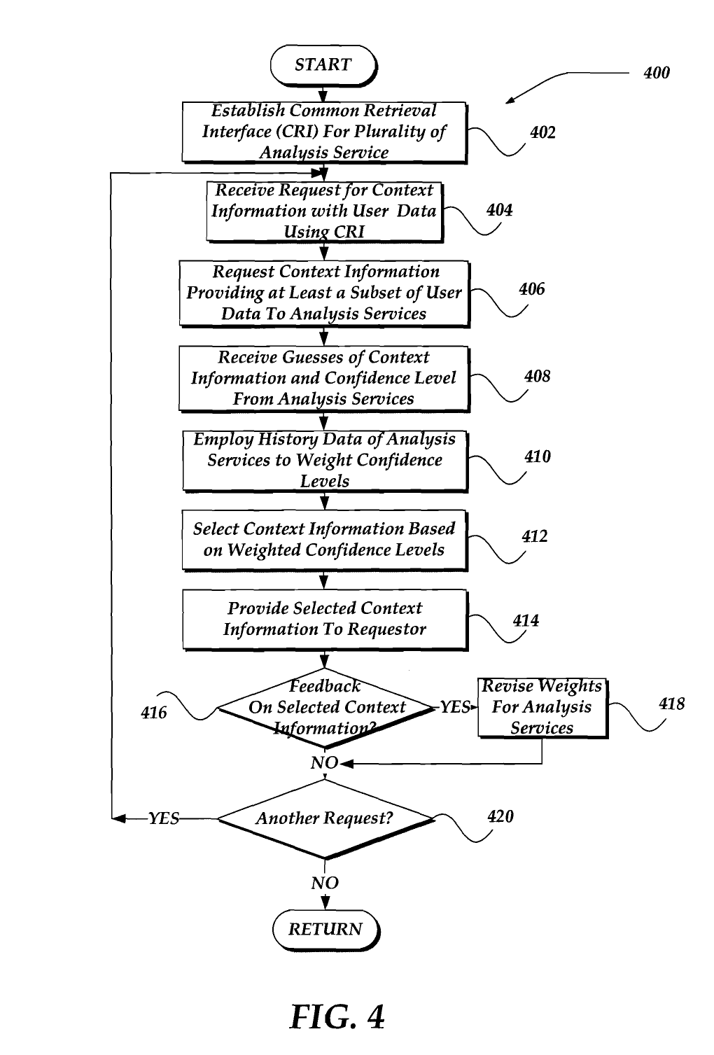

Context service 109 may interact with analysis services 120-122 to determine what type of user context information may be provided by the various analysis services. In one embodiment, each of analysis services 120-122 may provide a dictionary, or the like, indicating the user context information that the analysis service may provide. In one embodiment, the analysis services 120-122 may also indicate an interface format that may be used to request the user context information. Context service 109 may generate a global virtualized dictionary (VD) indicting the globally available user context information. Context service 109 may also generate and publish a common retrieval interface (CRI) that may be used by such as content services 107 to request the user context information. By employing context service 109, the burden of collecting, managing, retrieving, and selecting user context information from the various analysis services 120-122 is offloaded from content services 107. Moreover, use of context service 109 may further decouple development of content applications from user context information activities. One embodiment of a process useable by context service 109 to perform at least some of its actions is described in more detail below in conjunction with FIG. 4.

Analysis services 120-122 include a variety of devices configured and arranged to receive a request for user context information and to provide such user context information along with a confidence level. Analysis services 120-122 may receive with the request at least some user information, including, for example, but not limited to a device identifier, a user name, user alias, a carrier's identifier, content from within a message, or the like. Analysis services 120-122 may then employ some of the provided user information to determine the user context information. In one embodiment, different user information may be employed by at least two of the analysis services 120-122 to determine the user context information. For example, in one embodiment, analysis service 120 might employ a phone number or other device identifier to determine the user context information, while analysis service 121 might employ query history data, such as call history, or the like, to determine the user context information. Similarly, analysis service 122 might employ contents of a message to determine the requested user context information. The invention is not constrained to these examples, however, and it should be clear that other user information may be provided to analysis services 120-122 to determine the requested user context information.

Analysis services 120-122 may employ a variety of different mechanisms to determine a level of confidence in the determination of the user context information. For example, in one embodiment, confidence levels may be based on how current the underlying database information may be that is employed in determining the user context information. For example, where the analysis service may employ query history data to determine the user context information, confidence levels may be based on how recent the query was performed by the user. Similarly, where the determination is based on contents of the message, the confidence level may be based on a quantity of useable context information may be extracted from the message, or the like. In any event, analysis services 120-122 are configured to provide a confidence level within a standardized range, such as zero to 100%, or the like, where zero might indicate no confidence in the results, and a 100% might indicate perfect confidence in the results.

Devices that may operate as content services 107, context service 109, and/or analysis services 120-122 include personal computers, desktop computers, multiprocessor systems, microprocessor-based or programmable electronics, network PCs, servers, or other network devices.

### Illustrative Mobile Client Environment

FIG. 2 shows one embodiment of mobile device 200 that may be included in a system implementing the invention. Mobile device 200 may include many more or less components than those shown in FIG. 2. However, the components shown are sufficient to disclose an illustrative embodiment for practicing the present invention. Mobile device 200 may represent, for example, mobile devices 102-104 of FIG. 1.

As shown in the figure, mobile device 200 includes a processing unit (CPU) 222 in communication with a mass memory 230 via a bus 224. Mobile device 200 also includes a power supply 226, one or more network interfaces 250, an audio interface 252, a display 254, a keypad 256, an illuminator 258, an input/output interface 260, a haptic interface 262, and an optional global positioning systems (GPS) receiver 264. Power supply 226 provides power to mobile device 200. A rechargeable or non-rechargeable battery may be used to provide power. The power may also be provided by an external power source, such as an AC adapter or a powered docking cradle that supplements and/or recharges a battery.

Mobile device 200 may optionally communicate with a base station (not shown), or directly with another computing device. Network interface 250 includes circuitry for coupling mobile device 200 to one or more networks, and is constructed for use with one or more communication protocols and technologies including, but not limited to, global system for mobile communication (GSM), code division multiple access (CDMA), time division multiple access (TDMA), user datagram protocol (UDP), transmission control protocol/Internet protocol (TCP/IP), SMS, general packet radio service (GPRS), WAP, ultra wide band (UWB), IEEE 802.16 Worldwide Interoperability for Microwave Access (WiMax), SIP/RTP, or any of a variety of other wireless communication protocols. Network interface 250 is sometimes known as a transceiver, transceiving device, or network interface card (NIC).

Audio interface 252 is arranged to produce and receive audio signals such as the sound of a human voice. For example, audio interface 252 may be coupled to a speaker and microphone (not shown) to enable telecommunication with others and/or generate an audio acknowledgement for some action. Display 254 may be a liquid crystal display (LCD), gas plasma, light emitting diode (LED), or any other type of display used with a computing device. Display 254 may also include a touch sensitive screen arranged to receive input from an object such as a stylus or a digit from a human hand.

Keypad 256 may comprise any input device arranged to receive input from a user. For example, keypad 256 may include a push button numeric dial, or a keyboard. Keypad 256 may also include command buttons that are associated with selecting and sending images. Illuminator 258 may provide a status indication and/or provide light. Illuminator 258 may remain active for specific periods of time or in response to events. For example, when illuminator 258 is active, it may backlight the buttons on keypad 256 and stay on while the client device is powered. Also, illuminator 258 may backlight these buttons in various patterns when particular actions are performed, such as dialing another client device. Illuminator 258 may also cause light sources positioned within a transparent or translucent case of the client device to illuminate in response to actions.

Mobile device 200 also comprises input/output interface 260 for communicating with external devices, such as a headset, or other input or output devices not shown in FIG. 2. Input/output interface 260 can utilize one or more communication technologies, such as USB, infrared, Bluetooth™, or the like. Haptic interface 262 is arranged to provide tactile feedback to a user of the client device. For example, the haptic interface may be employed to vibrate mobile device 200 in a particular way when another user of a computing device is calling.

Optional GPS transceiver 264 can determine the physical coordinates of mobile device 200 on the surface of the Earth, which typically outputs a location as latitude and longitude values. GPS transceiver 264 can also employ other geo-positioning mechanisms, including, but not limited to, triangulation, assisted GPS (AGPS), E-OTD, CI, SAI, ETA, BSS or the like, to further determine the physical location of mobile device 200 on the surface of the Earth. It is understood that under different conditions, GPS transceiver 264 can determine a physical location within millimeters for mobile device 200; and in other cases, the determined physical location may be less precise, such as within a meter or significantly greater distances. In one embodiment, however, mobile device may through other components, provide other information that may be employed to determine a physical location of the device, including for example, a MAC address, IP address, or the like.

Mass memory 230 includes a RAM 232, a ROM 234, and other storage means. Mass memory 230 illustrates another example of computer storage media for storage of information such as computer readable instructions, data structures, program modules or other data. Mass memory 230 stores a basic input/output system (“BIOS”) 240 for controlling low-level operation of mobile device 200. The mass memory also stores an operating system 241 for controlling the operation of mobile device 200. It will be appreciated that this component may include a general purpose operating system such as a version of UNIX, or LINU™, or a specialized client communication operating system such as Windows Mobile™, or the Symbian® operating system. The operating system may include, or interface with a Java virtual machine module that enables control of hardware components and/or operating system operations via Java application programs.

Memory 230 further includes one or more data storage 244, which can be utilized by mobile device 200 to store, among other things, applications 242 and/or other data. For example, data storage 244 may also be employed to store information that describes various capabilities of mobile device 200. The information may then be provided to another device based on any of a variety of events, including being sent as part of a header during a communication, sent upon request, or the like. Data storage 244 may also store other information including, but not limited to messages, graphics, contact lists, text files, audio files, video files, or the like. At least a portion of the information may also be stored on a disk drive or other storage medium (not shown) within mobile device 200.

Applications 242 may include computer executable instructions which, when executed by mobile device 200, transmit, receive, and/or otherwise process messages (e.g., SMS, MMS, IM, email, and/or other messages), audio, video, and enable telecommunication with another user of another client device. Other examples of application programs include calendars, browsers, email clients, IM applications, SMS applications, VOIP applications, contact managers, task managers, transcoders, database programs, word processing programs, security applications, spreadsheet programs, games, search programs, and so forth. As shown, mobile device 200 includes browser 243 as one example of an application configured to display list content. Clearly, however, any of a variety of other applications may be configured to display list content, including, but not limited to email applications, calendar applications, game applications, video and/or audio access applications, or the like.

A user may employ one of the messaging applications within application 242 to send and/or receive messages. In one embodiment, the user might employ the messaging applications to perform a search, communicate messages to another user, or request information from a content service, such as content services 107 of FIG. 1, or the like. Similarly, the user might receive messages or the like, from another user, and/or content services 107. For example, the user might receive an advertisement, an email, a SMS alert, or the like, from content services 107, or the like. In one embodiment, the received message, content, or the like, might have been customized based on information about the user. Such customization is directed towards improving the relevancy of the message, content, or the like, to the user. For example, if the user receives a message that includes an advertisement, the selected advertisement sent to the user might have been customized based on user context information, such as a location of the user, a preference of the user, or the like. Furthermore, in one embodiment, the message might have been sent to the user at a selected user account, client device, or the like, based on the user context information.

### Illustrative Server Environment

FIG. 3 shows one embodiment of a network device, according to one embodiment of the invention. Network device 300 may include many more components than those shown. The components shown, however, are sufficient to disclose an illustrative embodiment for practicing the invention. Network device 300 may represent, for example, context service 109 of FIG. 1.

Network device 300 includes processing unit 312, video display adapter 314, and a mass memory, all in communication with each other via bus 322. The mass memory generally includes RAM 316, ROM 332, and one or more permanent mass storage devices, such as hard disk drive 328, tape drive, optical drive, and/or floppy disk drive. The mass memory stores operating system 320 for controlling the operation of network device 300. Any general-purpose operating system may be employed. Basic input/output system (“BIOS”) 318 is also provided for controlling the low-level operation of network device 300. As illustrated in FIG. 3, network device 300 also can communicate with the Internet, or some other communications network, via network interface unit 310, which is constructed for use with various communication protocols including the TCP/IP protocol. Network interface unit 310 is sometimes known as a transceiver, transceiving device, or network interface card (NIC).

The mass memory as described above illustrates another type of computer-readable media, namely computer storage media. Computer storage media may include volatile, nonvolatile, removable, and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computing device.

The mass memory also stores program code and data. One or more applications 350 are loaded into mass memory and run on operating system 320. Examples of application programs may include transcoders, schedulers, calendars, database programs, word processing programs, HTTP programs, customizable user interface programs, encryption programs, security programs, VPN programs, SMS message servers, IM message servers, email servers, account management and so forth. The mass memory may further include virtualized dictionary (VD) 342, common retrieval interface for VD (CRI) 344, and user information access manager (UIAM) 352.

VD 342 includes virtually any mechanism that may be configured to store and manage keywords, capabilities, and the like, for determining user context information. In one embodiment, VD 342 may include keywords that indicate the type of user context information that may be available through network device 300. For example, VD 342 might include keywords indicating that city location, state location, town location, county location, street location, country location information or the like for a user might be available. VD 342 might also include a variety of other keywords and/or capabilities, including, but not limited to user preference information, user account information, or the like. VD 342 may be implemented using a variety of mechanisms, including but not limited to databases, spreadsheets, XML style sheets, files, programs, scripts, or the like.

CRI 344 includes virtually any mechanism that may be configured and arranged to publish a common retrieval interface (CRI) useable to request and to receive user context information. For example, in one embodiment, CRI 344 may publish a CRI such as: Return_type_rest=get (string, keyword), where sting might indicate user information provided to UIAM 352, and keyword might indicate the type of user context information being sought. The result may include the user context information being sought. However, the invention is not limited to this interface and others may also be used.

UIAM 352 is configured and arranged to receive a request for user context information using the published CRI, and return user context information. UIAM 352 may receive various information with the request about the user, including but not limited to a user's phone number or other device identifier, a message, a “TO” or “From” device identifier, or the like. In one embodiment, UIAM 352 may extract selected information from the message that may be useable to determine the user context information. In another embodiment, UIAM 352 may provide the message, or other received user information within a request for user context information to one or more analysis services. UIAM 352 may provide different user information to different analysis services, in one embodiment. UIAM 352 may receive the user context information and a confidence level from each of the one or more analysis services. Then based on feedback about an analysis service, UIAM 352 may apply a weighting to respective confidence levels. UIAM 352 may then select user context information based, in part, on the weighted confidence levels. In one embodiment, however, UIAM 352 may compare the received user context information and employ another mechanism, such as voting, or the like, to select the user context information to be sent to the requester. UIAM 352 may employ a process such as described below in conjunction with FIG. 4 to perform at least some of its actions.

### Generalized Operation

The operation of certain aspects of the invention will now be described with respect to FIG. 4. FIG. 4 illustrates a logical flow diagram generally showing one embodiment of an overview of a process for performing a search for user context information using virtual dictionaries.

Process 400 of FIG. 4 begins, after a start block, at block 402, where a common retrieval interface (CRI) is established for a plurality of analysis services. During initialization, in one embodiment, a plurality of analysis services may be identified that are available to provide user context information. For example, one analysis service may be available to receive a user's phone number, and in return provide a location associated with the phone number. In one embodiment, the location may be specified in terms of a city, a town, a county, a state, a country, or the like. In one embodiment, information from prior query histories of a user may be employed by another analysis service to determine a location of the user. In still another example, yet another analysis service may employ contents extracted from a message sent or received by the user to determine a location of the user. The plurality of analysis services is not limited to these examples, however, and other analysis services with the plurality might employ other user related information as input to provide location information. Moreover, the analysis services are not constrained to providing location information. For example, given a phone number or other user associated identifier, at least one of the analysis services might be configured to provide a history of search queries performed by the user, an account identifier associated with the user for receiving alerts or emails, or the like. The plurality of analysis services may further provide a variety of other user context information in addition to or even instead of these examples. For example, in one embodiment the user context information provided might include, but not be limited to, user preferences, user browsing history, user search history, user buddy lists, contacts, or the like.

Because the plurality of analysis services may provide a variety of different user context information, during initialization, that list of available user context information is collected from each of the plurality of analysis services. In one embodiment, that list of available user context information may be used to generate a global virtualized dictionary (VD). Moreover, in one embodiment, a common retrieval interface (CRI) may also be generated that provides a listing of the capabilities what the various analysis services. In one embodiment, the CRI specifies a standardized interface format for requesting user context information. The CRI may then be published or otherwise made available to various content services for use in improving a relevancy of content to be provided to a user. Thus, for example, when a content service seeks to improve a relevancy of a search results, it may employ the CRI to request, in one embodiment, user context information such as user location information, preferences, or the like.

Thus, process 400 flows next to block 404, where a content service, may provide a request for user context information. In one embodiment, the content service may provide some user data to use in determining the user context information. The user data provided for the request may include a phone number of the user, a phone number the user might have called, a message including a message body, an identifier of a carrier associated with the user's client device, or the like. In one embodiment, the request may be formatted using the standardized interface format. In one embodiment, the format may include an indication of the type of user context information being sought, such as location information, account information, or the like, including that mentioned above.

Processing continues next to block 406, where the user data provided for the request may include a message, or the like. Moreover, the request might seek, for example, location information about the user. Thus, at block 406, the message might be examined to determine whether any of the message body or the like, might indicate location information. For example, the message body might include a discussion about the best pizza in Seattle is at X diner. Thus, the location Seattle might be extracted from the message body. The extracted data and other user data provided for the request may then be used in requests to the appropriate subset of analysis services that are configured to determine the requested user context information. Thus, for example, if the requested user context information is location, then the subset of analysis services for which user data might be sent to include those analysis services that return location information. Moreover, because each of the analysis services might employ different user data, a different subset of the user data might be sent to different analysis services. For example, one analysis service might employ a phone number to determine a location. Another analysis service might employ a query history to determine a location, while still another analysis service might employ the extracted message data to determine a location. In one embodiment, the query history might be obtained within the provided user data. In another embodiment, the query history might be obtained from another analysis service based on a phone number, account number, or the like.

In any event, processing then flows to block 408, where guesses of the requested user context information requested is provided from the subset of analysis services. Along with the guesses may also be a confidence level. The confidence level may be determined by the analysis services based on how confident it may be with the correctness of the returned user context information. Such confidence levels may be virtually any value, typically within a defined range, such as zero to 100%, or the like, where zero might, in one embodiment, indicate low or no confidence, and 100% might indicate perfect or high confidence. However, other values, ranges, or the like, may also be used. Moreover, the determination of the confidence levels may be based on a variety of criteria, including, but not limited, to prior success histories, an amount of data used to determine the user context information, or the like. For example, consider the case where the analysis service employs query histories by the user to determine location. If the query history includes few or no location information, then the confidence level returned might be very low. However, if the query history includes recent queries and the recent queries included location information, then the confidence level returned might be very high.

Processing continues to block 410, where history data associated with the analysis services may then be used to weight the confidence levels returned. For example, if it is determined that a given analysis service appears to provide incorrect, irrelevant, or the like, user context information, then the weighting of confidence levels for that analysis service might be lower. As an example, consider that location information is sought. Further, in a prior request for location information, analysis service “A” was selected to provide location information. However, within a defined period of time, another request for location information is made for the same user. This may indicate that the prior location information was incorrect, irrelevant, or the like. Thus, the weighting for analysis service “A” might be set to decrease the value of information from analysis server “A,” in the future. In one embodiment, the weighting may be specific to a user. In another embodiment, the weighting may be independent of a specific user. In any event, weighting may be increased or decreased for confidence levels, based on feedback from various sources.

Process 400 continues next to block 412, where user context information is selected based on comparing the weighted confidence levels for the subset of analysis services. In one embodiment, the user context information is selected based on a highest weighted confidence level. In one embodiment additional analysis may be performed based on the received user context information. For example, if several of the analysis services returned the same user context information, that user context information might be selected. Thus, in one sense, the weighting of confidence levels, may be based on cross comparisons of user context information between analysis services. In any event, processing continues to block 414, where the selected user context information is provided to the requestor for use in improving the relevancy of content provided to the user. For example, if the user was requesting a best pizza restaurant. The location of the user might be used as part of the search query to find the best pizza restaurant within a defined distance from the selected user's location.

Processing moves to decision block 416 where a determination is made whether there is any feedback on the selected user context information provided. For example, as noted above, if another request for location information for the same user is received within a defined time period, it may indicate that the location information was incorrect, irrelevant, or the like. However, other sources of feedback may also be obtained, including messages from the requester, or the like. If feedback is received, processing moves to block 418; otherwise, processing flows to decision block 420. At block 418, the feedback is used to revise weighting values for the analysis services. Processing then continues to decision block 420.

At decision block 420, a determination is made whether another request for user context information is received. If so, processing loops back to block 404; otherwise, processing returns to perform other actions.

It will be understood that each block of the flowchart illustration, and combinations of blocks in the flowchart illustration, can be implemented by computer program instructions. These program instructions may be provided to a processor to produce a machine, such that the instructions, which execute on the processor, create means for implementing the actions specified in the flowchart block or blocks. The computer program instructions may be executed by a processor to cause a series of operational steps to be performed by the processor to produce a computer implemented process such that the instructions, which execute on the processor to provide steps for implementing the actions specified in the flowchart block or blocks. The computer program instructions may also cause at least some of the operational steps shown in the blocks of the flowchart to be performed in parallel. Moreover, some of the steps may also be performed across more than one processor, such as might arise in a multi-processor computer system. In addition, one or more blocks or combinations of blocks in the flowchart illustration may also be performed concurrently with other blocks or combinations of blocks, or even in a different sequence than illustrated without departing from the scope or spirit of the invention.

Accordingly, blocks of the flowchart illustration support combinations of means for performing the specified actions, combinations of steps for performing the specified actions and program instruction means for performing the specified actions. It will also be understood that each block of the flowchart illustration, and combinations of blocks in the flowchart illustration, can be implemented by special purpose hardware-based systems which perform the specified actions or steps, or combinations of special purpose hardware and computer instructions.

The above specification, examples, and data provide a complete description of the manufacture and use of the composition of the invention. Since many embodiments of the invention can be made without departing from the spirit and scope of the invention, the invention resides in the claims hereinafter appended.

What is claimed as new and desired to be protected by Letters Patent of the United States is:

1. An apparatus that is operative to prepare content for use on a mobile device over a network, comprising:
a memory component for storing data and instructions; and
a processing component for executing instructions that enables actions, including:
receiving a request for user context information about a user of the mobile device, where the request is received with at least some user information;
providing a first subset of the user information to a first context analysis application;
providing a second subset of the user information to a second context analysis application;
receiving from the first context analysis application a first user context information and a first level of confidence;
receiving from the second context analysis application a second user context information and a second level of confidence;
selecting one of the first or the second user context information based on a comparison of the first and second level of confidences; and
providing the selected user context information over the network such that the selected user context information is useable to modify a relevancy of content provided to the user.

2. The apparatus of claim 1, wherein the processing component enables actions, further comprising:
publishing a common retrieval interface specifying a type of user context information available and a format useable to request the user context information; and
wherein the received request employs the common retrieval interface.

3. The apparatus of claim 1, wherein selecting one of the first or the second user context information based on a comparison further comprises:
receiving feedback about a prior user context information provided by at least one of the first or second context analysis application;
employing the feedback about the at least one of the first or second context analysis application to weight the respective level of confidences; and
comparing the resulting weighted level of confidences to select user context information.

4. The apparatus of claim 1, wherein the user context information includes at least one of a current location of the user, a recent purchase by the user, or a user account associated with the user.

5. The apparatus of claim 1, wherein the at least some user information further comprises at least one of a mobile device identifier, a message from the user; a ‘TO’ address associated with the message, or a carrier identified associated with the mobile device.

6. The apparatus of claim 1, wherein the first subset of user information includes at least some user information different from the second subset of user information.

7. A processor-readable storage medium having processor-executable instructions for managing content for use on a mobile device over a network, the processor-executable instructions when installed onto a computing device enable the computing device to perform actions, comprising:
receiving, from a content service application, a request for user context information about a user, and at least some user information;
providing a subset of the user information to a plurality of different context analysis applications;
receiving from each of the different context analysis applications in the plurality, user context information and a confidence level for the provided user context information;
selecting user context information from one of the different context analysis application based on a comparison of the respective confidence levels; and
providing the selected user context information to the content service application, wherein the selected context information is useable to modify a relevancy of content provided to the user.

8. The processor-readable storage medium of claim 7, wherein the user context information includes at least one of a current location of the user, a recent purchase by the user, or a user account associated with the user.

9. The processor-readable storage medium of claim 7, wherein the at least some user information further comprises at least one of a mobile device identifier, a message from the user; a ‘TO’ address associated with the message, or a carrier identified associated with the mobile device.

10. The processor-readable storage medium of claim 7, wherein the content service application is configured to provide content associated with at least one of a search query, an advertisement, or an alert.

11. The processor-readable storage medium of claim 7, wherein the processor-executable instructions when installed onto a computing device enable the computing device to perform actions, further comprising:
receiving feedback on the provided selected user context information;
employing the feedback to weight another confidence level obtained from the context analysis application corresponding to the selected user context information; and
using the weighting in another comparison to select another user context information.

12. A system useable in managing content for use on a mobile device, comprising:
a plurality of context analysis services configured to provide user context information and a confidence level associated with the provided user context information;
a context service coupled to the plurality of context analysis services, and configured and arranged to perform actions, including:
receiving, from a content service application, a request for user context information about a user, and at least some user information;
providing a subset of the user information to each context analysis service in the plurality of context analysis service;
receiving from each of the context analysis services, user context information and an associated confidence level for the provided user context information;
selecting user context information from one of the context analysis application based on a weighted comparison of the respective confidence levels; and
providing the selected user context information to the content service application, wherein the selected context information is useable to modify a relevancy of content provided to the user.

13. The system of claim 12, wherein based on a weighted comparison further comprises:
receiving feedback about a prior user context information provided by at least one of the plurality of context analysis services, wherein the feedback indicates whether the user context information is relevant to user;
employing the feedback to weight the level of confidence from the corresponding context analysis service.

14. The system of claim 12, wherein the at least some user information further comprises at least one of a mobile device identifier, a message from the user; a ‘TO’ address associated with the message, or a carrier identified associated with the mobile device.

15. The system of claim 12, wherein the user context information includes at least one of a current location of the user, a recent purchase by the user, or a user account associated with the user.

16. The system of claim 12, wherein the selected user context information is useable to modify is at least one of a search query, an advertisement, or an alert.

17. A method of managing a content over a network, comprising:
receiving a request for user context information about a user, and at least some user information;
providing subsets of the user information to each context analysis service in the plurality of context analysis service, wherein at least one of the context analysis services receives a different subset of the user information than another context analysis service;
receiving from each of the context analysis services, user context information and an associated confidence level for the provided user context information;
selecting user context information from one of the context analysis application based on a weighted comparison of the respective confidence levels;
enabling the selected user context information to be used to modify a relevancy of content provided to the user.

18. The method of claim 17, wherein the at least some user information further comprises at least one of a mobile device identifier, a message from the user; a ‘TO’ address associated with the message, or a carrier identified associated with the mobile device.

19. The method of claim 17, wherein the selected user context information is useable to modify is at least one of a search query, an advertisement, or an alert.

20. A modulated data signal configured to include program instructions for performing the method of claim 17.
